(19) United States
(12) Patent Application Publication
(10) Pub. No.: US 2010/0122177 A1
(43) Pub. Date: May 13, 2010

(54) CONTENT REPRODUCTION SYSTEM, CONTENT REPRODUCTION/CONTROL APPARATUS, AND COMPUTER PROGRAM

(75) Inventor: Akio Yoshioka, Kawaguchi (JP)

Correspondence Address: MORRISON & FOERSTER LLP, 425 MARKET STREET, SAN FRANCISCO, CA, 94105-2482, US

(73) Assignee: ACCESS CO., LTD., Chiyoda-ku, Tokyo (JP)

(21) Appl. No.: 12/593,602

(22) PCT Filed: Feb. 18, 2008
(86) PCT No.: PCT/JP2008/052632

§ 371 Date: Sep. 28, 2009

(30) Foreign Application Priority Data
Mar. 28, 2007 (JP) 2007-085991

(51) Int. Cl. G06F 3/048; G06F 15/16

(52) U.S. Cl. 715/738

(57) ABSTRACT

A DMP/DMC (dual terminal) (10) has both of a content reproduction function for reproducing a content, and a content controller function for controlling the delivery of the content from a content server to an arbitrary delivery destination and the reproduction of the content. The dual terminal (10) accepts the selection of the content from its operation unit, and receives a designation of the delivery destination to deliver the content from the DMS (content server) 20. The dual terminal switches the GUI setting for its display unit, depending on whether the delivery destination is the terminal itself or an apparatus provided with the content reproduction function. Accordingly, operability on the terminal can be enhanced.

### TECHNICAL FIELD

The present invention relates to a system for reproducing contents among a plurality of apparatuses in a home network, and a graphic user interface (GUI) in a content reproduction/control apparatus used for the content reproduction.

### BACKGROUND ART

In recent years, there is proposed a home network for sending and receiving commands and data between a personal computer (PC) and a digital appliance, or between digital appliances. According to techniques such as the DLNA (Digital Living Network Alliance) or BLUETOOTH (registered trademark), it is already possible for audio-visual (AV) related digital appliances (TV receiver, PC, audio system, HDD recorder, and the like) to perform linkage operation therebetween. By way of example, digital contents such as music, photograph, moving images can be shared seamlessly among a home electric appliance, a PC, and mobile equipment. Specifically, it is possible to carry out operations such as reproducing music stored in the PC by an audio system for listening the music, enjoying a moving image stored in the PC by a large-screen TV receiver, or reproducing moving image contents stored in the HDD recorder by a PC placed in another room. The DLNA standard defines a plurality of functional parts such as a DMP (Digital Media Player), DMS (Digital Media Server), DMC (Digital Media Controller), and DMR (Digital Media Renderer), and specifications thereof are determined respectively.

In general, it is known that, a device on which a user carries out an operation employs a GUI (Graphic User Interface) screen as a user interface for enhancing the user's operability. In the GUI screen, preferably, there are arranged information presented for helping the operation, item information as an object to be selected, an operation menu, an instruction button, and the like. Input specifications of a relating input device are defined in association with the GUI screen. Typically, the GUI screen is different with respect to each application being used. As for a switching of GUI screens, the patent document 1 proposes a following technique; in a vehicle-mounted apparatus provided with a remote commander and a touch panel, GUI screens appropriate for respective input methods are prepared, and the GUI screens are switched according to a predetermined operation by a user.

[Patent document 1]

### Japanese Unexamined Patent Application Publication No. 2005-98831

### DISCLOSURE OF THE INVENTION

### Problem to be Solved by the Invention

Recent mobile phone terminal devices (the terminal device will be simply referred to as “terminal”) remarkably grow and expand in functionality and such terminals are now getting able to treat multimedia, without any difficulty, such as a text, audio sound, image, and moving image. There appears a mobile phone terminal which is equipped with a wireless communication means, not only a mobile phone communication but also a communication facility such as a wireless LAN or BLUETOOTH (registered trademark). According to the background as described above, it is expected that a mobile terminal such as the mobile phone terminal may serve as a DLNA-compliant device. It is considered that this type of mobile terminal is allowed to be functioning as a player (DMP) which reproduces the content by itself, as well as functioning as a controller (DMC). Implementation of both the DMP and DMC functions at the same time may be achieved on other terminal, not restricted to the mobile phone.

A player (DMP) and a controller (DMC) used conventionally, are respectively provided with separate GUIs individually, and a manner of screen transition is different from each other. Specifically, there are differences as described below, with regard to moving image contents.

In the DMP, there is displayed a list screen for displaying a list of moving image contents being made public by the DMS. In the list screen, when a user selects a moving image content that he or she wants to reproduce and instructs to start the reproduction, the screen is switched from the “list screen” to a reproduction screen for reproducing the moving image content.

On the other hand, in the DMC, even though the steps are the same until the user selects from the list screen the moving image content that he or she wants to reproduce, it is not necessary for the screen of DMC to switch the screen to the “reproduction screen”, since the DMC relegates the moving image reproduction to a DMR (reproducer). Alternatively, a control screen for controlling the reproduction in the DMR is displayed usually.

In view of the situation above, one terminal having both the DMP function and the DMC function at the same time (referred to as “dual terminal”) may be assumed. Since the GUI screens and their transition are different between the DMP and the DMC, it is considered that individual applications are developed separately and incorporated into the dual terminal, startup icons or a menu is prepared for the user to activate the individual applications, allowing the user to select one, and GUI screens and the transition thereof suitable for either one of the DMP and the DMC are provided. For this case, the user selects the DMP application when he or she wants to output the moving image content in the screen of the dual terminal itself which the user is currently operating. On the other hand, when the user wants to output the moving image content on a DMR other than the dual terminal, the user selects the DMC application. Furthermore, once one of the applications is activated, it is necessary to restart the other application in order to switch a delivery destination of the moving image content while playing the same. Such switching of applications is cumbersome for the user.

More particularly, it does not seem to be easy for a user in an ordinary household to recognize concepts of the DMP and DMC and accomplish changeover therebetween.

The present invention has been made in view of the background as described above, and it is directed to enhancing operability of a terminal provided with both the two functions; a content reproduction function for reproducing a content delivered from a content server, and a content controller function for controlling the delivery of the content from the content server to any delivery destination and the reproduction of the content.

### Means to Solve the Problem

A content reproduction system includes a content server provided with a content delivery function which stores a plurality of contents and delivers a content being designated to a designated apparatus, a content reproduction/control apparatus provided with a content controller function for controlling a delivery to any delivery destination according to the content delivery function and a reproduction of the content, and a content reproduction function for reproducing the content delivered from the content server according to a control of the content controller function, and a content reproduction apparatus provided with the content reproduction function; the content server, the content reproduction/control apparatus, and the content reproduction apparatus being connected to one another via a communication network, wherein, the content reproduction/control apparatus includes; a display unit for displaying the content, an operation unit for accepting an operation instructed by a user, a communication unit for establishing connection with the communication network, and a control unit for controlling each of the units, wherein, the control unit, serving as the content controller function, receives from the operation unit, a selection of the content together with a designation of a delivery destination of the content, and a GUI setting for the display is switched depending on whether the delivery destination being designated is the apparatus itself or the apparatus provided with the content reproduction function.

As a part of the content controller function, the control unit accepts a change of the delivery destination even while the content is being reproduced, and if switching of the delivery destination is performed between the apparatus itself and any other content reproduction apparatus, it is also possible to change the GUI setting.

The present invention can be understood as the content reproduction/control apparatus in the system described above.

For example, the content reproduction/control apparatus may be provided with a means for selectively generating a first screen having a list display area for displaying a content list, and a menu area including a menu item for designating a type of the content as an object to be displayed on the content list and a second menu item for designating a delivery destination of the content; a second screen having a content display area for displaying at least the content being reproduced; and a third screen having an operation display area for displaying at least operation elements related to the reproduction of the content. For this case, the control unit, serving as the content controller function, switches the display unit from the first screen to the second screen if the apparatus itself is designated as the delivery destination when it is instructed to reproduce the content selected in the first screen, and switches the display unit from the first screen to the third screen if any other content reproduction apparatus is designated as the delivery destination.

The third screen includes a list display area for displaying the content list, and it is also possible to display information within the content item, indicating that the content is in the course of being reproduced.

At least one of the second screen and the third screen may include a menu item for switching the delivery destination of the content.

The content reproduction/control apparatus according to the present invention is a content reproduction/control apparatus provided with both a DMP function and a DMC function of the DLNA standard, and the content reproduction/control apparatus determines which function is to be selected depending on a predetermined condition, provides prepared GUI screens selectively according to the function being selected, and controls a transition between the screens.

More particularly, a computer program according to the present invention allows the content reproduction/control apparatus to execute the following functions; a function for collecting list information of contents from at least one server connected to a communication network, a function for displaying the list information being collected on a display unit, a function for receiving a designation of a content from the list information, a function for receiving a designation of a delivery destination of the content being designated, and a function for switching a GUI setting for the display unit, depending on whether the delivery destination being designated is the apparatus itself or an apparatus provided with the content reproduction function. It is also possible to understand the present invention as a recording medium on which the computer program is recorded in such a manner as readable. Here, the recording medium includes a semiconductor recording medium such as an ROM and a flash memory, a disk-type recording medium such as a flexible disk (FD), hard disk (HD), and digital versatile disk (DVD), and any medium which is able to perform recording in a non-volatile manner.

### EFFECT OF THE INVENTION

According to the present invention, it is automatically determined which function is to be used according to an operation for selecting a delivery destination of the content, and therefore, selection from both functions can be adequately performed without user's consciousness as to which function is to be taken; the content reproduction function or the content controller function. Consequently, it is possible to enhance the operability of the terminal provided with the both function

### BRIEF DESCRIPTION OF THE DRAWINGS

FIG. 1 illustrates a schematic configuration of a home network system according to the present embodiment;

FIG. 2 illustrates an example of hardware configuration of the DMP/DMC (dual terminal) as shown in FIG. 1;

FIG. 3 illustrates an example of hardware configuration of the DMS as shown in FIG. 1;

FIG. 4 illustrates a configuration example of a monitor device as an example of the DMR as shown in FIG. 1;

FIG. 5 illustrates GUI screens and their transition examples in the dual terminal having a display screen with a relatively large size as shown in FIG. 1(a);

FIG. 6 illustrates a transition between screens when the delivery destination is switched after the dual terminal as shown in FIG. 5 functioning as the DMP starts the content reproduction;

FIG. 7 illustrates GUI screens and their transition example of the dual terminal having a display screen with a relatively small size as shown in FIG. 1(b);

FIG. 8 illustrates a transition example of the GUI screens when the delivery destination is switched while the content is being reproduced on the dual terminal as shown in FIG. 7; and

FIG. 9 is a flowchart showing a processing example that is executed by the control unit of the DMP/DMC according to an embodiment of the present invention.

### DENOTATION OF REFERENCE NUMERALS

10 . . . DUAL TERMINAL, 25 . . . COMMUNICATION NETWORK, 50a, 50b, 50c, 50d . . . SCREEN, 51 . . . MENU AREA, 52 . . . LIST AREA, 53 . . . BAR DISPLAY AREA, 54 . . . CONTENT REPRODUCTION AREA, 55 . . . OPERATION SCREEN, 57 . . . OPERATION AREA, 59 . . . PLAYING INDICATION, 70a, 70b, 70c, 70d . . . SCREEN, 72 . . . LIST AREA, 73 . . . CONTENT REPRODUCTION AREA, 74 . . . OPERATION GUIDE PART, 75 . . . OPERATION UNIT, 76 . . . OPERATION AREA, 77 . . . POP-UP MENU, 78 . . . SUB-MENU, 79 . . . OPERATION AREA, 101 . . . CENTRAL CONTROL UNIT, 102a . . . VARIOUS PROGRAMS, 104 . . . FLASH MEMORY, 105 . . . ANTENNA, 106 . . . TELEPHONE COMMUNICATION UNIT, 107 . . . DISPLAY DRIVER, 109 . . . AUDIO PROCESSOR, 111 . . . MICROPHONE, 112 . . . SPEAKER, 113 . . . OPERATION UNIT, 114 . . . ANTENNA, 115 . . . SHORT-DISTANCE WIRELESS COMMUNICATION UNIT, 201 . . . CENTRAL CONTROL UNIT, 206 . . . NETWORK INTERFACE, 208 . . . EXTERNAL STORAGE DEVICE, 211 . . . RECORDING REPRODUCTION UNIT, 220 . . . BUS, 301 . . . CENTRAL CONTROL UNIT, 304 . . . IMAGE PROCESSOR, 305 . . . DISPLAY UNIT, 306 . . . NETWORK INTERFACE, 307 . . . AUDIO PROCESSOR, 308 . . . SPEAKER, 320 . . . BUS, 511, 512, 513, 514, 515 . . . MENU ITEM, 520 . . . CONTENT ITEM, 521 . . . ICON, 522 . . . CONTENT TITLE, 551 . . . MENU ITEM, 553 . . . END BUTTON, 571 . . . OPERATION BUTTON GROUP, 572 . . . MENU ITEM, 722 . . . EACH CONTENT ITEM, 751, 752, 753 . . . KEY

### BEST MODE FOR CARRYING OUT THE INVENTION

Hereinafter, a preferred embodiment of the present invention will be explained, with reference to the accompanying drawings.

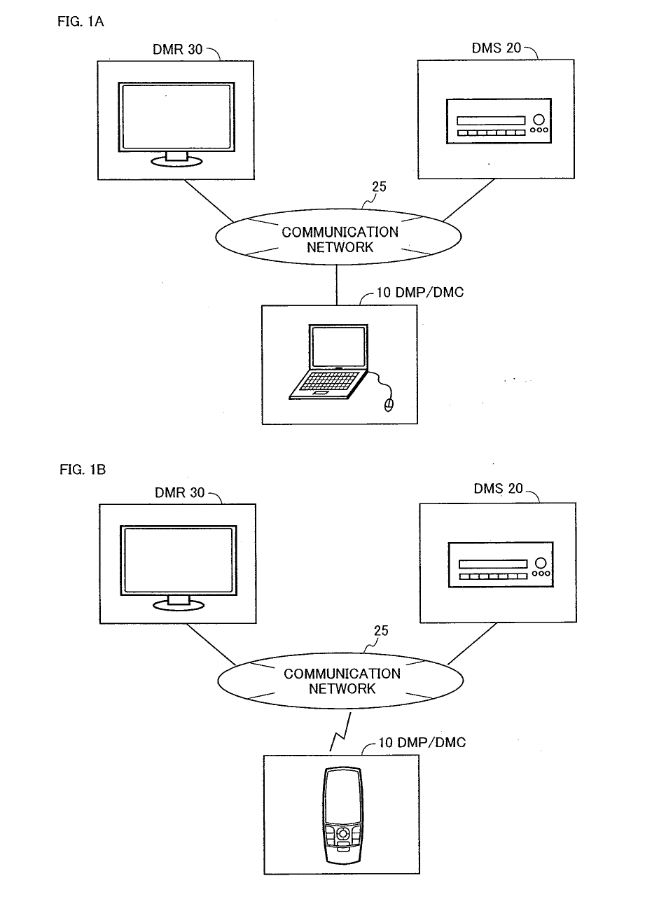

FIG. 1 illustrates two examples of schematic configuration of the DLNA-standard home network system as one embodiment of the content reproduction system according to the present invention. In any of the examples of the system, a DMP/DMC (dual terminal) 10, serving as a content reproduction/control apparatus having a content controller function for controlling a delivery of the content to any delivery destination by a content delivery function of the present invention, and a content reproduction function for reproducing the content being delivered from a content server according to the control by the content controller function, a DMS 20 serving as the content server provided with the content delivery function for deliver the content being designated to an apparatus being designated, and a DMR 30 serving as a content reproduction apparatus having the content reproduction function, are connected to one another via the communication network 25. The dual terminal 10 shown in FIG. 1(a) is a fixed terminal such as a PC, and the dual terminal 10 shown in FIG. 1(b) is a mobile terminal such as a mobile phone terminal. The two terminals are different from each other in the size of display screen and an input device depending on whether it is a non-portable type or portable type, and therefore, these factors may influence the GUI screens as described below. Any of a wired network and a wireless network may serve as the communications network 25, and any network constructed by mixing both may be applicable.

Each of the DLNA-standard functional parts is as follows:

(1) DMS is a server for managing moving image contents to be shared on the communication network, and placing the contents open to the public. A PC, a set-top box, a digital camera, a video camera, or the like, may serve as the DMS;
(2) DMP is a player to reproduce the moving image contents placed open to the public by the DMS. A TV receiver, a digital music player, a stereo set, or the like, may serve as the DMP;
(3) DMC is a controller to operate the control such as starting, stopping, and fast-forwarding the reproduction; and
(4) DMR is a renderer exclusively for reproducing the content according to the control by the DMC. The DMR does not have a user interface for the operations such as selecting and reproducing the content. A video monitor, a speaker, or the like, may serve as the DMR.

It is possible to say that the DMP has both the functions of the DMC and DMR. Individual DLNA compliant device may be provided with one or more functions. In other words, each of the DMR, DMP, DMC, DMR, and the like, may represent functional parts (roles) of the DLNA standard, and they are not necessarily independent apparatuses. By way of example, one apparatus may be provided with the DMS and DMC functions, another apparatus may be provided with the DMS and DMP functions. Further alternatively, one apparatus may be provided with the DMS and DMR functions.

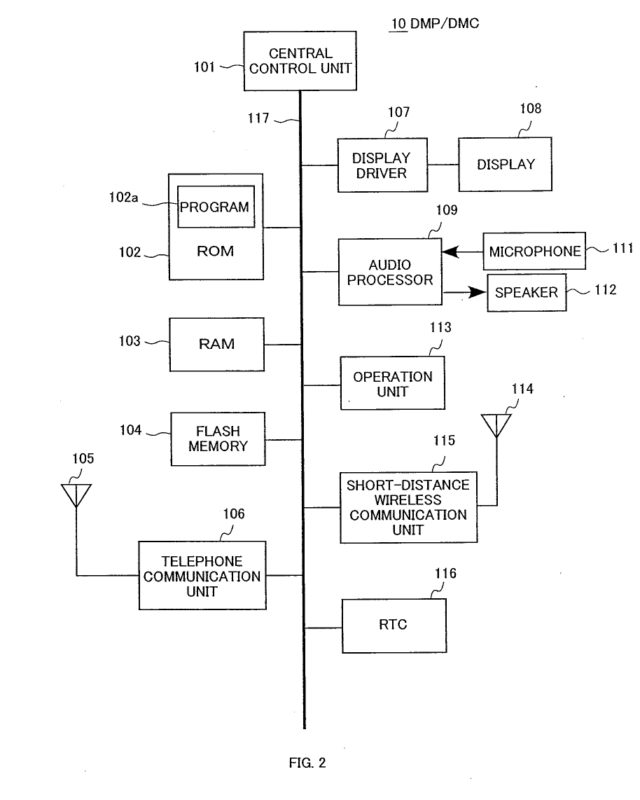

FIG. 2 illustrates an example of hardware configuration of the DMP/DMC (dual terminal) 10. Here, there is shown an example of a mobile phone terminal.

The control of the DMP/DMC 10 is implemented when a central control unit 101 (e.g., CPU) performs a program control. An ROM 102 is typically a read-only memory which stores various programs 102a such as a control program for the control, an application program equipped initially, and fixed data. An RAM 103 is a readable and writable memory providing a temporary data storage area and a work area. A flash memory 104 is a rewritable memory which stores various data in non-volatile manner. The program may also be stored in the flash memory 104, in addition to the ROM 102. An application program for the DMP/DMC use in the dual terminal according to the present embodiment may be installed in advance, or may be downloaded afterwards. This application program may include a data group constituting the GUI screens, a display control program for displaying the screens, an input control program, a communication control program, and the like.

A telephone communication unit 106 is not essential in the present invention, but it is a part for establishing wireless audio and data communications with the base station via an antenna 105. A display driver 107 is controlled by the central control unit 101, performs a process for drawing various information items, and displays the information on the screen of the display (display device) 108 serving as a display unit. An audio processor 109 is connected to a microphone 111 and a speaker 112, to perform audio processing under the control of the central control unit 101. An operation unit 113 is a part for controlling the input interface, and it may include a keyboard having various keys such as ten-keys and cursor movement operation keys, a mouse, a remote control, and a touch panel. A short-distance wireless communication unit 115 is a part for establishing connection with the communication network 25, and it is connected to an antenna 114 to perform short-distance wireless communications under the control of the central control unit 101. By way of example, a wireless adapter such as a wireless LAN or BLUETOOTH (registered trademark) serves as this communication unit. An RTC 116 is a real time clock to provide functions such as a clock, a calendar, and a timer.

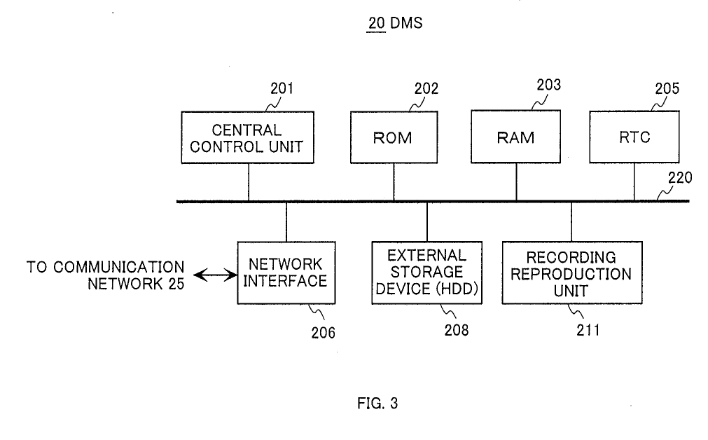

FIG. 3 illustrates an example of hardware configuration of the DMS 20. Control of the DMS 20 is implemented when a central control unit (e.g., CPU) 201 performs a program control. The central control unit 201 is connected to each part via a bus 220. An ROM 202 is typically a read-only memory for storing a boot program for starting the DMS 20 and necessary fixed data. An RAM 203 is a readable and writable memory to provide a temporary area for saving data and a work area. An RTC 205 is a real time clock to provide functions such as a clock, calendar, and timer. A communications network interface 206 is a part being connected to the communication network 25 to provide a communication function. An external storage device 208 is a high capacity storage device for storing programs and content data in non-volatile manner, and typically it is a hard disk device (HDD). However, it may include other storage device such as a DVD. A recording reproduction unit 211 is a part for reproducing the contents within the external storage device 208, and for recording the contents given from the outside into the external storage device 208. More particularly, though not illustrated, it is possible to provide a means for accepting an operation from an infrared wireless remote control, or the like.

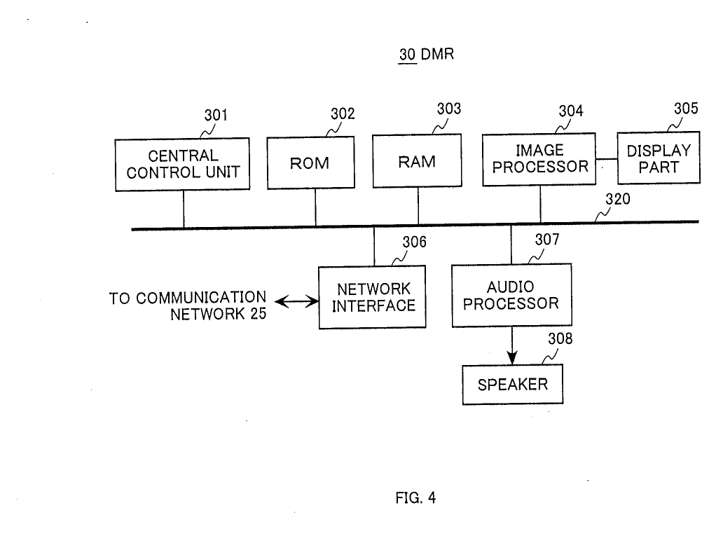

FIG. 4 is a block diagram showing a configuration example of a monitor device as one example of the DMR 30. The DMR 30 is implemented when a central control unit (CPU) 301 performs a program control. The central control unit 301 is connected to each part via a bus 320. An ROM 302 is typically a read-only memory which stores a control program for the control, an application program equipped initially, and fixed data. The RAM 303 is readable and writable memory providing a temporary data storage area and a work area. An image processor 304 has functions to perform image processing on the content received from the communication network 25 via a network interface 306, and to display the content on a display unit 305. The display unit 305 may be any type of display device, such as a liquid crystal display device, a CRT display device, or a plasma display device. The display unit has a function to optically display a screen image based on the signals from the image processor 304. The network interface 306 has functions to establish connection with the communications network 25, and to exchange data therebetween. An audio processor 307 is connected to a speaker 308, and performs audio processing under the control of the central control unit 301. Though not illustrated, a microphone connected to the audio processor 307 may also be provided. More particularly, though not illustrated, a broadcasting receiver and IR photo receiver may also be provided, so as to accept operations on the broadcasting receiver from an infrared remote control.

In the system configuration as described above, hereinafter, operations of the present embodiment will be explained.

In the present embodiment, it is automatically determined in the dual terminal which function is to be used according to user's operation details, without the user's consciousness as to the DMC and DMP functions, and in accordance with the determination result, a GUI setting is performed suitable for either of the DMC and DMP. According to the GUI setting, it is decided which GUI screen is employed and how to switch the GUI screens, in response to which operation has been taken. The GUI setting includes not only the GUI screen display, but also setting of the input interface of the operation unit in association with the screen.

More specifically, the DMC function and the DMP function are integrated into one application, and a means is provided for allowing the user to select a delivery destination (output destination) of the content from the DMS. According to a result of the selection, it is determined whether the apparatus is to be functioned as the DMP or the DMC, and according to the determination result, the GUI setting suitable for either of the functions is performed. A selection of the delivery destination of the content; the dual terminal (apparatus) itself or other apparatus (for example, DMR), is actually associated with the function that the dual terminal takes; DMP or DMC. In other words, if the dual terminal itself is assumed as the delivery destination, it indicates that the dual terminal operates as the DMP, whereas if a terminal other than the dual terminal is assumed as the delivery destination, it indicates that the dual terminal operates as the DMC. Accordingly, the inventor of the present application have conceived a configuration that the dual terminal itself automatically determines to serve as DMC or DMP, when a certain operation is carried out, without the user's consciousness as to both functions. Unlike the implementation where a user is made to select DMC or DMP in an initial menu and according to the selection result, either application is selectively activated, the configuration above does not require to terminate and restart the application any more.

In the present embodiment, it is assumed that the GUI setting is switched between the DMP and DMC under the following conditions, for instance:

(1) The GUI setting is switched according to the change of delivery destination of the content from the DMS (the destination is either the dual terminal itself or other apparatus). This change of the delivery destination is allowed even after starting the content reproduction (during the reproduction).
(2) It is automatically switched from the DMC to the DMP when a situation happens that the content cannot be reproduced in the DMR even though the delivery destination is set to be the DMR. By way of example, this situation may occur in the cases such as shutting down the DMR (e.g., power-off) and disconnecting the DMR from the LAN. This situation requires changing of the delivery destination, and it is possible to assume that this situation also corresponds to “the change of delivery destination” in a broad sense. Since the shutdown (e.g., power-off) of the DMR is equivalent to disconnection of the DMR from the LAN, if the disconnection of the DMR from the LAN is detected, it is sufficient to recognize the situation. A method for the detection is to provide a means in the DMC for checking the state of communication network connection of the DMR. Specifically, this detection can be performed, for example, by the DMC which checks regularly the connection with the DMR via the communication network, acquires a result of checking performed by the other apparatus, or the like. For that purpose, a program for executing this checking means is stored in the ROM 102 or the flash memory 104 of the DMP/DMC 10, and the central control unit 101 executes the program.

The DMC may hold the controller function as a background processing of any other application being executed. By way of example, when the dual terminal has a television broadcast receiving function, receiving and reproducing of the television broadcasting are allowed while the control function is activated, and if necessary, it is possible to utilize the dual terminal as the controller immediately, according to the operation of the user. In addition, also when the screen of the dual terminal is switched to the menu (e.g., launcher menu) allowing the user to select an application he or she wants to start, it is similarly possible to hold the controller function.

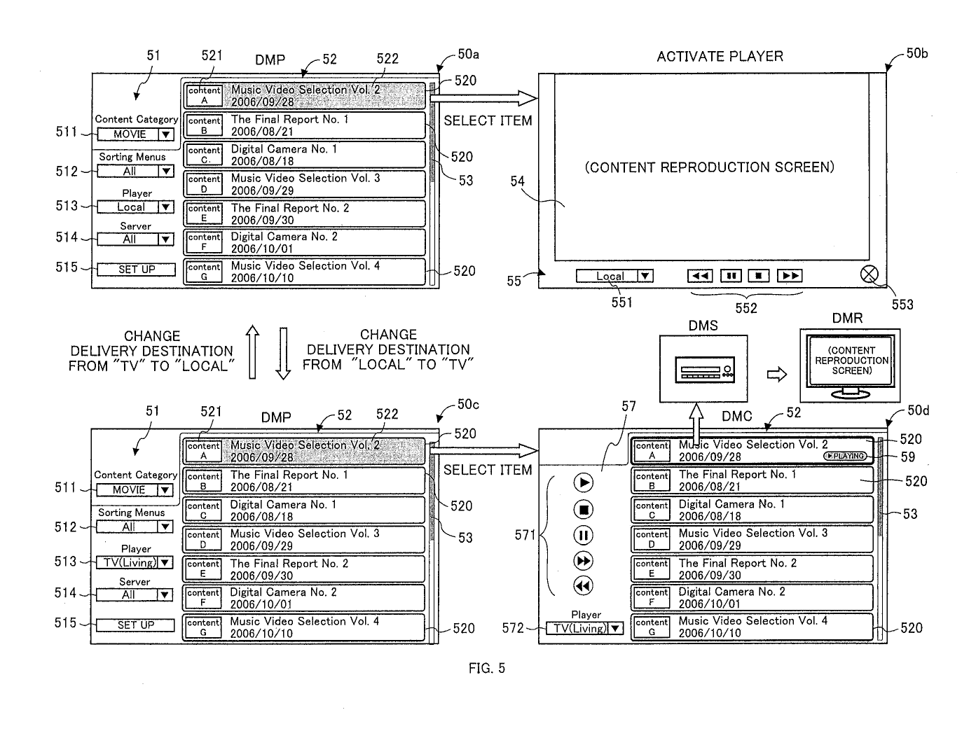

FIG. 5 illustrates GUI screens and their transition examples of the dual terminal having a display screen with a relatively large size as shown in FIG. 1(a). In FIG. 5, there are shown four screens 50a to 50d.

The screen 50a (first screen) displays a list of the contents as reproduction objects when the terminal is serving as the DMP. In the menu area 51 on the left side of the screen, menu items are vertically arranged, which are user-selectable. In the list area 52 on the right side of the menu area 51, a content list is displayed to show a list of the contents. On the right end of the screen 50a, there is arranged a bar display area 53 to indicate a ratio and a position of a group of contents being displayed, relative to all the contents in the content list.

More specifically, in the menu area 51, there are arranged a menu item 511 for selecting a category (i.e., a type) of the contents such as moving images, static images, and music; a menu item 512 for sorting the content list being displayed with a desired sorting method; a menu item 513 for designating (selecting) a delivery destination of the content; a menu item 514 for selecting a server which is connected to the home network; and a menu item 515 for configuring various settings.

In the list area 52, a content list is displayed, including the contents in the server being designated and sorted with a designated sorting method. Each content item 520 in the content list includes an icon 521 representing the content and a content title 522. As the icon 521, a thumbnail image of a head frame may be displayed if the content is a moving image, and if it is a static image, a thumbnail image thereof may be displayed. If the content is music content, a thumbnail image of a jacket of the music or the like may be displayed. In the example being illustrated, date and time of acquisition (or date and time of generation) are also displayed together with the content title 522.

A user is allowed to select a desired content item in the screen 50a via an operation unit being provided, and instruct to reproduce the content item. A mouse or a keyboard may be used as the operation unit in the case of a PC. Other type of operation unit may be employed, such as a remote control and a touch panel depending on the system. The content item being selected is displayed in enhanced manner, by a reversing display, a highlighted display, or the like.

When the user instructs to reproduce the content item being selected in the screen 50a, the dual terminal is set to be “Local” indicating that the current delivery destination is the apparatus itself, and therefore, the player of the apparatus itself is started as the DMP. Then, the screen of the dual terminal is changed to the screen 50b as shown in the upper-right portion of FIG. 5. Furthermore, the dual terminal directs the server (DMS) to deliver the content via the communication network, assuming the apparatus itself as the delivery destination.

The screen 50b (second screen) includes the content reproduction area 54 for displaying the content reproduction screen which spreads almost all over the area, and an operation area 55 provided on the lower side of the screen in this example. In the operation area 55, there are arranged elements such as a menu item 551 for designating the delivery destination, an operation button group (operation elements) 552 for carrying out reproduction-related operations such as stopping, pausing, fast-forwarding, and rewinding, and an end button 553 for terminating the content reproduction. It is assumed that the stop button in the example is changed to a play button while the reproduction stays stopped. Alternatively, it is possible to configure such that both the play button and the stop button are displayed constantly. When the end button 553 is designated, the screen is returned to the screen 50a.

The screen 50c in the lower-left portion of FIG. 5 shows the state that the delivery destination has been switched from “Local” to “TV (Living)” as the DMR (This screen 50c is also the first screen). Only one DMR is shown as an option of the delivery destination, but there is a possibility that more than one DMR exists. Even though the same content is selected as in the case of the screen 50a, if a reproduction directive is given in this state, the dual terminal instructs the sever (DMS) being designated, via the communication network, to deliver the content to the TV (Living), which is assumed as the delivery destination. The function of the dual terminal is switched from the DMP to the DMC, and the screen 50b of the DMP is changed to the screen serving as the DMC, as shown in the screen 50d (the third screen) at the lower-right portion of FIG. 5.

In the screen 50d, the operation area 57 is placed instead of the menu area 51 of the screen 50c. In the operation area 57, there are arranged an operation button group 571 for carrying out the reproduction-related operations, and a menu item 572 for designating the delivery destination. In the screen 50d of the DMC, the display screen of the dual terminal itself is not used for displaying the content reproduction, and therefore, the list area 52 for displaying the content list remains as it is. It is to be noted, however, that a playing indication 59 is added to the content being reproduced, within the content item 520. In addition, displaying manner of the content item being currently selected is different from that of DMP. It is to be noted that the operation button groups 552 and 571 are not necessarily included respectively in the screen 50b and 50d, if corresponding operation buttons and the like are prepared on a separate operation unit such as a remote control.

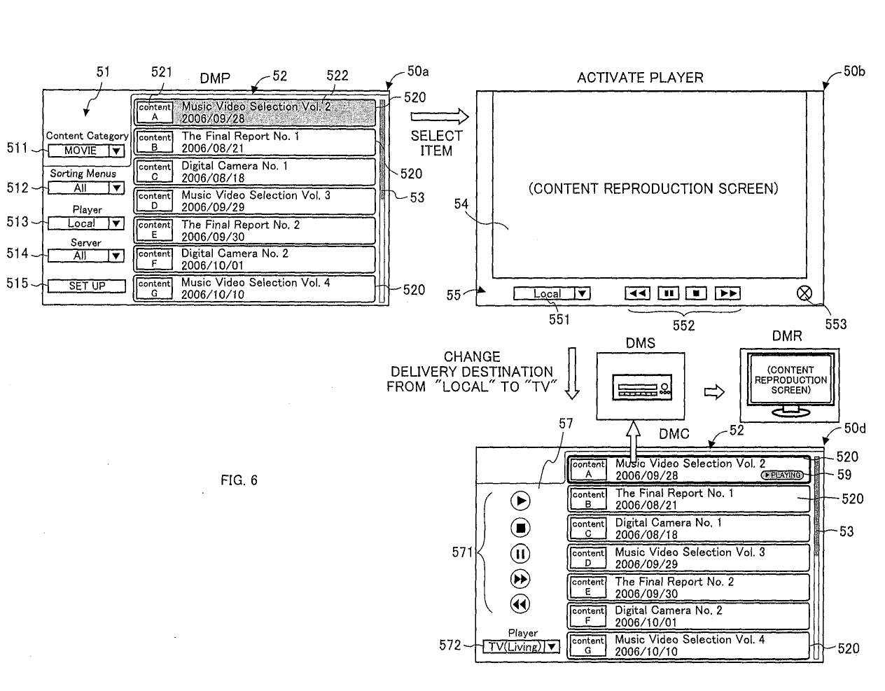

FIG. 6 illustrates a transition between screens when the delivery destination is switched from “Local” to “TV (Living)” in the menu item 551, while the content is being reproduced as shown in the screen 50b, after the content reproduction is started as the DMP in the screen 50a of the dual terminal as shown in FIG. 5. The present embodiment allows the delivery destination is to be switched, even while the content is being reproduced in the terminal serving as the DMP. On this occasion, the screen is switched from the screen 50b indicating that the player of the DMP is activated, to the screen 50d of the DMC. As for the content being reproduced, the delivery destination thereof is changed from the dual terminal itself to the DMR.

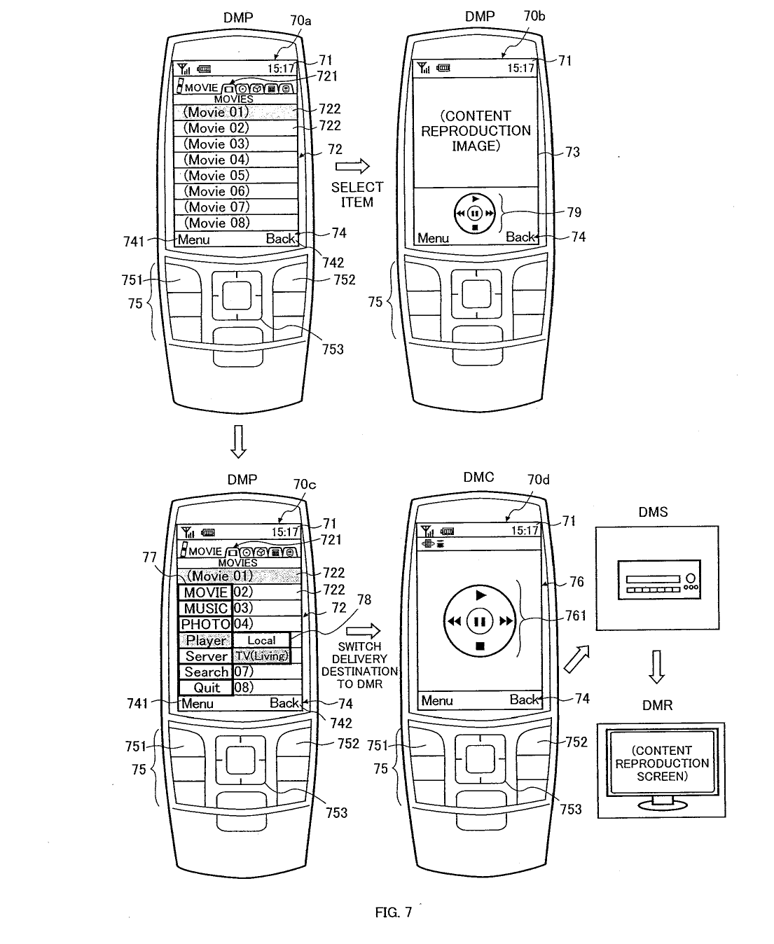

FIG. 7 illustrates GUI screens and their transition examples of the dual terminal having a display screen with a relatively small size as shown in FIG. 1(b). In here, a mobile phone terminal is taken as an example of the dual terminal and in the figure, there are shown four screens 70a to 70d.

The screen 70a (first screen) displays a list of the contents as reproduction objects when the terminal is serving as the DMP. In the primary list area 72 of the screen, there is displayed a content list to show a list of the contents. In the upper side of the area, there are displayed a plurality of tags 721 each indicating a category of the content currently selected. In the figure, there is shown a state that the category “MOVIE” is selected. An operation guide part 74 is displayed in the lower portion of the list area 72. An operation unit 75 as hardware is arranged under the screen 70a. In the operation unit 75, there are provided keys such as a key 753 which integrates a directional key for indicating four directions and a decision key, and keys 751, 752, each including three elements on both sides. In the example shown in the figure, the keys 751 and 752 are associated with the soft keys as shown in the operation guide part 74.

In the screen 70a, displayed details of each content item 722 is not specifically illustrated, but similar to the example above, it may include the icon and the content title representing the content.

When the user designates “Menu” shown in the operation guide part 74, a pop-up menu 77 is displayed as shown in the screen 70c. (This screen 70c is also the first screen). As the menu items, category options of the content, a menu item for selecting the delivery destination, a menu item for selecting a server, a menu item for searching, and the like, are displayed. The screen 70c shows the state that when the menu item for selecting the delivery destination is designated from the pop-up menu 77, a submenu 78 presenting options of the delivery destination is further displayed. It is configured such that “Local” or “TV (Living)” as described in the aforementioned example is allowed to be selected from the submenu 78.

In the screen 70a, the user is allowed to select a desired content item via the operation unit 75 to provide an instruction for reproduction. The content item being selected is displayed in enhanced manner by a reversing display, a highlighted display, or the like.

When it is instructed to reproduce the content being selected in the screen 70a, the delivery destination is set to be “Local” as a default, indicating that the delivery destination is the apparatus itself. Then, the dual terminal activates the player of the apparatus itself as the DMP, and the screen is changed to the screen 70b (second screen) as shown in the upper-right portion in FIG. 7. Furthermore, the dual terminal instructs the server (DMS) being designated, to deliver the content assuming the apparatus itself as the delivery destination, via the communication network.

The screen 70b includes a content reproduction area 73 for displaying the content reproduction screen which spreads almost all over the area, and an operation area 79 provided on the lower side of the screen in this example. In the operation area 79, there is an operation button group for carrying out reproduction-related operations such as playing, stopping, pausing, fast-forwarding, and rewinding. Display of the operation area 74 is a guide display indicating functions assigned to the corresponding keys in the operation unit 75. (It is to be noted that if a touch panel is provided, the displayed key itself may serve as the operational object). In the example of the figure, there is no indication of stop key for stopping the reproduction, and it may be additionally displayed. Alternatively, stopping may be possible by using a predetermined key in the operation unit 75, without providing aforementioned additional key. When the “Menu” of the screen 70b is designated, a pop-up menu similar to the screen 70c is displayed. If specific buttons are provided on the terminal, the operation area 79 is not necessarily required.

The screen 70b in the lower-left portion of FIG. 7 indicates the state that the delivery destination has been switched from “Local” to “TV (Living)” as the DMR. Even though the same content is selected as in the case of the screen 70a, if a directive of reproduction is given in this state, the dual terminal instructs the sever (DMS) being designated, via the communication network, to deliver the content assuming the TV (Living) as the delivery destination. The function of the dual terminal is switched from the DMP to the DMC, and the screen 70b of the DMC is changed to the screen serving as the DMC, as shown in the screen 70d (third screen) at the lower-right portion of FIG. 7. As for the dual terminal as shown in FIG. 7, the display screen is not large. Therefore, in the screen 70d of the DMC, the display screen of the dual terminal itself is not used for displaying the content, but the operation area 76 is displayed for carrying out the operation related to the content reproduction, instead of the list area 72. In the operation area 76, there is arranged an operation button group 761 for conducting the operation related to the reproduction. The operation area 76 may function as a guide display for the actual operation unit, or may serve as a touch panel to receive an instruction directly. It is to be noted that the terminal shown in the figure is a model in which ten-keys and control keys covered behind (not illustrated) make an appearance, when the bottom end on the lower side of the operation unit 75 is made slide downwardly. If specific buttons are provided on the terminal, the operation area 761 is not necessarily required.

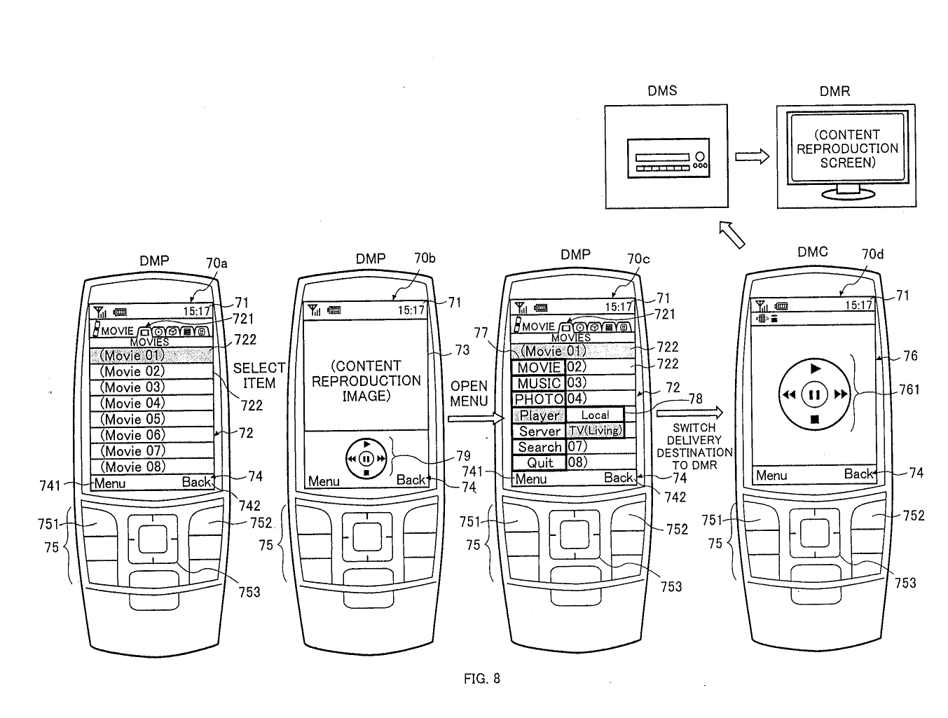

As explained in FIG. 6, switching of the delivery destination while the content is being reproduced is carried out also in the dual terminal as shown in FIG. 7. FIG. 8 is a figure to explain such operations as described above. In FIG. 8, corresponding elements are labeled the same as shown in FIG. 7, and the operations thereof shall not be tediously explained. In the operation of FIG. 8, the transition between screens is different from the operation of FIG. 7. In other words, after shifting from the screen 70a to the screen 70b and while the content is being reproduced, the delivery destination is switched to the DMR, i.e., TV (living) in this example here, by using the “Menu”.

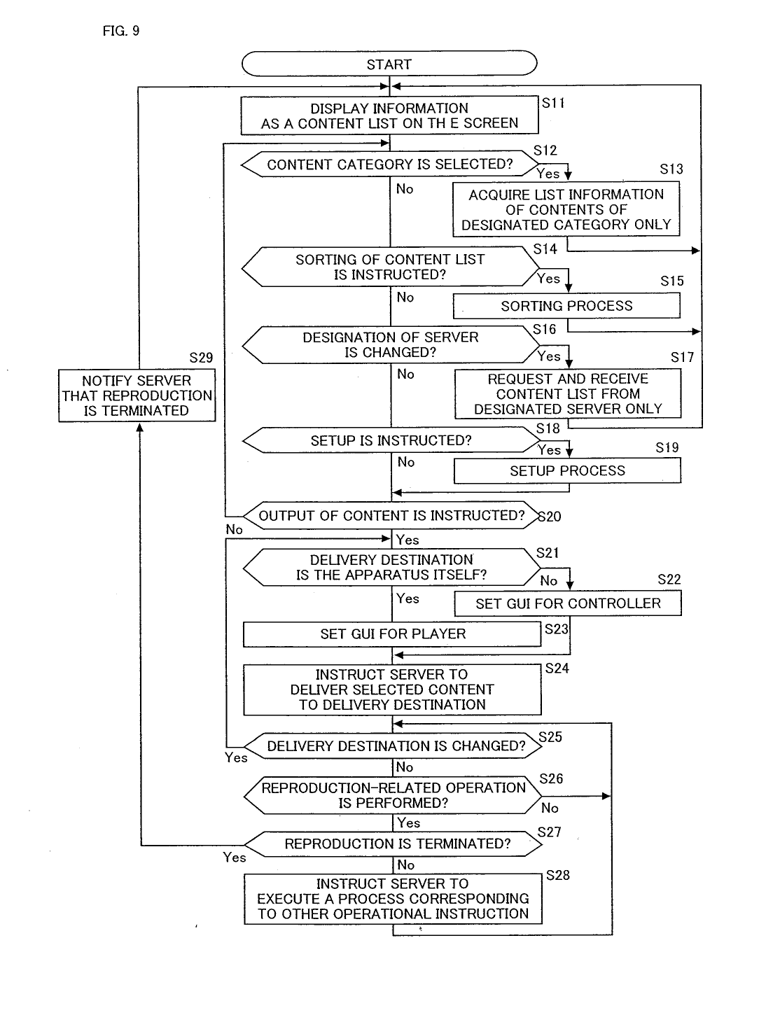

FIG. 9 is a flowchart showing a processing example that is executed by the control unit of the DMP/DMC 10 according to the present embodiment. This processing is implemented when the central control unit 101 executes a computer program stored in the storage unit such as the ROM 102.

When the DMP/DMC function of the dual terminal is activated, firstly, according to the default settings, list information of the contents is collected from all the DMSs connected to the communication network, and the information is displayed as a content list on the screen (S11). Subsequently, if the category selection (switching) of the contents occurs (S12, Yes), list information of the contents only of the category being designated, is collected again from all the DMSs connected to the communication network (S13), and the processing returns to step S11. On this occasion, it is also possible to configure such that information of only the contents of the category being designated is extracted as display objects, from the already-obtained contents list without accessing the server. If there is an instruction to sort the content list (S14, Yes), a sorting process is carried out according to the instruction (S15), and the processing returns to step S11. If there is a change in the server designation (S16, Yes), the content information is requested only to the server being designated, the information is received therefrom (S17), and the processing returns to step S11. If there is an instruction to configure settings of various function (set-up) (S18, Yes), the set-up processing is executed (S19), and the processing returns to step S11.

When a content is selected from the content list, and there is an instruction to output the content (reproduction instruction) (S20, Yes), it is checked whether or not the delivery destination being selected is the apparatus itself (S21). If it is the apparatus itself, a player as described above is activated as the DMP, and the GUI setting for the player is configured (S23). If the delivery destination is not the apparatus itself (i.e., other apparatus such as DMR), the GUI setting for the controller as the DMC is configured (S22).

Subsequent to the steps S22 and S23, it is instructed to the server which stores the content, to deliver the content being selected to the delivery destination (S24). Afterwards, if there is any change in the delivery destination (S25, Yes), the processing returns to step S21. If any reproduction-related operation is carried out (S26, Yes) and the operation is to terminate the reproduction (S27, Yes), the server is notified that the reproduction is terminated to stop the delivery (S29), and the processing returns to step S11. If it is the operation other than terminating the reproduction, the server is instructed to execute a processing corresponding to the operation instruction (S28), and the processing returns to step S25.

The preferred embodiment of the present invention has been explained, but it is intended that the invention embraces various modifications and variations other than the exemplary embodiment described above.

By way of example, in the above explanation, the delivery destination is directly changed by the user. However, it is also possible to configure such that the delivery destination is changed as a result of changing an element other than the delivery destination. An example of such case above, it is considered that the delivery destination is changed according to a selection of image quality.

1. A content reproduction system comprising; a content server provided with a content delivery function which stores a plurality of contents and delivers a content selected from the plurality of contents to a destination, a content reproduction/control apparatus provided with a content controller function for controlling a delivery to any delivery destination according to the content delivery function and a reproduction of the content, and a content reproduction function for reproducing the content delivered from the content server according to a control of the content controller function, and a content reproduction apparatus provided with the content reproduction function; the content server, the content reproduction/control apparatus, and the content reproduction apparatus being connected to one another via a communication network, wherein,
the content reproduction/control apparatus comprises;
a display unit for displaying the content,
an operation unit for accepting an operation instructed by a user,
a communication unit for establishing connection with the communication network, and
a control unit for controlling each of the units, wherein,
the control unit, serving as the content controller function, receives from the operation unit, a selection of the content together with a designation of a delivery destination of the content, and a GUI setting for the display is switched depending on whether the delivery destination being designated is the apparatus itself or the content reproduction apparatus provided with the content reproduction function.

2. The content reproduction system according to claim 1, wherein,
the control unit, serving as the content controller function, accepts a change of the delivery destination even while the content is being reproduced, and changes the GUI setting when switching of the delivery destination is performed between the apparatus itself and any other content reproduction apparatus.

3. A content reproduction/control apparatus used in the content reproduction system comprising; a content server provided with a content delivery function which stores a plurality of contents and delivers a content selected from the plurality of contents to a destination, the content reproduction/control apparatus provided with a content controller function for controlling a delivery to any delivery destination according to the content delivery function and a reproduction of the content, and a content reproduction function for reproducing the content delivered from the content server according to a control of the content controller function, and a content reproduction apparatus provided with the content reproduction function; the content server, the content reproduction/control apparatus, and the content reproduction apparatus being connected to one another via a communication network, wherein, the content reproduction/control apparatus comprises;
a display unit for displaying the content,
an operation unit for accepting an operation instructed by a user,
a communication unit for establishing connection with the communication network, and
a control unit for controlling each of the units, wherein,
the control unit, serving as the contents controller function, receives from the operation unit, a selection of the content together with a designation of a delivery destination of the content, and a GUI setting for the display is switched depending on whether the delivery destination being designated is the apparatus itself or the content reproduction apparatus provided with the content reproduction function.

4. The content reproduction/control apparatus according to claim 3, wherein,
the control unit, serving as the content controller function, accepts a change of the delivery destination even while the content is being reproduced, and changes the GUI setting when the switching of the delivery destination is performed between the apparatus itself and any other content reproduction apparatus.

5. The content reproduction/control apparatus according to either of claim 3 and claim 4, comprising,
a means for selectively generating a first screen having a list display area for displaying a content list, and a menu area including a menu item for designating a type of the content as an object to be displayed on the content list and a second menu item for designating a delivery destination of the content; a second screen having a content display area for displaying at least the content being reproduced; and a third screen having an operation display area for displaying at least operation elements related to the reproduction of the content, wherein,
the control unit, serving as the content controller function, switches the display unit from the first screen to the second screen if the apparatus itself is designated as the delivery destination when it is instructed to reproduce the content selected in the first screen, and switches the display unit from the first screen to the third screen if any other content reproduction apparatus is designated as the delivery destination.

6. The content reproduction/control apparatus according to claim 5, wherein,
the third screen includes a list display area for displaying the content list, and displays information within a content item, indicating that the content is being reproduced.

7. The content reproduction/control apparatus according to either of claim 5, wherein,
at least one of the second screen and the third screen includes a menu item for switching the delivery destination of the content.

8. A content reproduction/control apparatus comprising both a DMP function and a DMC function of the DLNA standard, wherein,
the content reproduction/control apparatus determines which function is to be selected according to a predetermined condition, selectively provides GUI screens prepared in advance according to the function being selected, and controls a transition between the GUI screens.

9. A computer program allowing a content reproduction/control apparatus to execute;
a function for collecting list information of contents from at least one server connected to a communication network,
a function for displaying the list information being collected on a display unit,
a function for receiving a designation of a content from the list information,
a function for receiving a designation of a delivery destination of the content being designated, and
a function for switching a GUI setting for the display unit, depending on whether the delivery destination being designated is the apparatus itself or an apparatus provided with a content reproduction function.

10. A computer-readable storage medium having computer readable instructions for execution on a content reproduction/control apparatus, the instructions comprising:
collecting list information of contents from at least one server connected to a communication network,
displaying the list information being collected on a display unit,
receiving a designation of a content from the list information,
receiving a designation of a delivery destination of the content being designated, and
switching a GUI setting for the display unit, depending on whether the delivery destination being designated is the apparatus itself or an apparatus provided with a content reproduction function.
